(19) United States
(12) Patent Application Publication
(10) Pub. No.: US 2009/0309874 A1
(43) Pub. Date: Dec. 17, 2009

(54) Method for Display of Pre-Rendered Computer Aided Diagnosis Results

(75) Inventors: Marcos Salganicoff, Bala Cynwyd, PA (US); Arun Krishnan, Exton, PA (US); Sarang Lakare, Chester Springs, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/420,430

(22) Filed: Apr. 8, 2009

Related U.S. Application Data
(60) Provisional application No. 61/060,572, filed on Jun. 11, 2008.

(51) Int. Cl. G06T 15/00

(52) U.S. Cl. 345/419

(57) ABSTRACT

A method for displaying pre-rendered medical images on a workstation includes receiving three-dimensional medical image data. A region of suspicion is automatically identified within the three-dimensional medical image data. A rendering workstation is used to pre-render the three-dimensional medical image data into a sequence of two-dimensional images in which the identified region of suspicion is featured from a vantage point that is automatically selected to maximize diagnostic value of the two-dimensional images for determining whether the region of suspicion is an actual abnormality. The sequence of pre-rendered two-dimensional images is then stored in a PACS, where it can then be displayed on a viewing workstation.

### CROSS-REFERENCE TO RELATED APPLICATION

The present application is based on provisional application Ser. No. 61/060,572, filed Jun. 11, 2008, the entire contents of which are herein incorporated by reference.

### BACKGROUND OF THE INVENTION

1. Technical Field

The present disclosure relates to computer aided diagnosis and, more specifically, to methods for displaying pre-rendered computer aided diagnosis results.

2. Discussion of Related Art

Computer aided diagnosis (CAD) pertains to the use of artificial intelligence to process medical image data and locate one or more regions of interest within the medical image data. These regions of interest may correspond to, for example, locations that are determined to be of an elevated likelihood for including an anatomical irregularity that may be associated with a disease, injury or defect. Often CAD is used to identify regions that appear to resemble lesions.

In general, CAD may be used to identify regions of interest that may then be inspected closely by a trained medical professional such as a radiologist. By utilizing CAD, a radiologist can reduce the chances of failing to properly identify a lesion and may be able to examine a greater number of medical images in less time and with improved accuracy.

Medical image data may be acquired from one or more of a variety of modalities such as X-ray, Positron Emission Tomography (PET), Single Photon Emission Computed Tomography (SPECT), magnetic resonance (MR) imagery, computed tomography (CT), and ultrasound. The resulting medical image data may be three-dimensional. It is this three-dimensional medical image data that may be analyzed by the CAD system. After the CAD system has identified one or more regions of interest, the location of those regions of interest may be marked on the three-dimensional medical image data so that the radiologist can focus attention at the particular locations to determine if there is an actual lesion.

Theoretically, the radiologist could review the three-dimensional medical image data from a high-powered three-dimensional image rendering station. This would give the radiologist the ability to view the region of suspicion and the surrounding tissue from any desired angle. In practice, however, high-powered three-dimensional rendering stations are not always available to the radiologist during routine reads. Accordingly, radiologists often view two-dimensional renderings of the medical image data on less powerful two-dimensional viewing stations connected to picture archiving systems (PACS) which can only effectively display two-dimensional rendered gray-scale data.

The radiologist may then view a rendered version of the medical image data from the PACS viewing station. However, viewing image data from such a station may not be ideal as it is possible that a suitable angle for diagnosing a particular region of suspicion is not present in the two-dimensional image rendering. Moreover, when viewing three-dimensional image data within a gray-scale two-dimensional viewing station, a gray level window is generally selected. The selection of the gray level window affects how easy it is to differentiate between different types of tissue. In rendering the image data for display on the PACS, it is also possible that a suitable windowing of gray-levels for diagnosing a particular region of suspicion has not been provided.

### SUMMARY

A method for displaying pre-rendered medical images on a workstation includes receiving three-dimensional medical image data. A region of suspicion is automatically identified within the three-dimensional medical image data. A rendering workstation is used to pre-render the three-dimensional medical image data into a sequence of two-dimensional images in which the identified region of suspicion is featured from a vantage point that is automatically selected to maximize diagnostic value of the two-dimensional images for determining whether the region of suspicion is an actual abnormality. The sequence of pre-rendered two-dimensional images is displayed on a viewing workstation that is distinct from the rendering workstation.

The three-dimensional medical image data may include a CT scan, an MRI or an ultrasound image.

The sequence of two-dimensional images may include a series of image frames that can be replayed as a moving image. When displayed on the viewing workstation, the moving image may be shown to move forward and backwards through the series of image frames according to user input. The moving image may include a virtual fly-by animation from the point of view of a virtual camera. The position of the virtual camera may change as the animation progresses with the virtual camera pointed at the region of suspicion throughout the entire animation. The flight path of the virtual camera may be determined based on the location of the region of suspicion relative to the surrounding image data.

The region of suspicion may be a lesion candidate.

In pre-rendering the three-dimensional medical image data into a sequence of two-dimensional images, the vantage point of maximum diagnostic value may be selected by calculating a viewing angle and viewing distance that clearly illustrates the region of suspicion and adjacent tissue.

The sequence of two-dimensional images may include multiple views of the region of suspicion from various angles.

A method for pre-rendering medical images, in a rendering workstation, for display on a viewing workstation includes receiving three-dimensional medical image data. A region of suspicion is automatically identified within the three-dimensional medical image data. The three-dimensional medical image data is pre-rendered into a sequence of two-dimensional images in which the identified region of suspicion is featured from a vantage point that is automatically selected to maximize diagnostic value of the two-dimensional images for determining whether the region of suspicion is an actual abnormality. The sequence of pre-rendered two-dimensional images is exported and stored in a PACS for subsequent viewing.

The three-dimensional medical image data may include a CT scan, an MRI or an ultrasound image.

The sequence of two-dimensional images may include a series of image frames that may be replayed as a moving image. The moving image may Include a virtual fly-by animation from the point of view of a virtual camera. The position of the virtual camera may change as the animation progresses with the virtual camera pointed at the region of suspicion throughout the entire animation. The flight path of the virtual camera may be determined based on the location of the region of suspicion relative to the surrounding image data.

The region of suspicion may be a lesion candidate.

In pre-rendering the three-dimensional medical image data into a sequence of two-dimensional images, the vantage point of maximum diagnostic value may be selected by calculating a viewing angle and viewing distance that clearly illustrates the region of suspicion and adjacent tissue with a minimum of obstruction from surrounding view-occluding tissue. The sequence of two-dimensional images may include multiple views of the region of suspicion from various angles.

A computer system includes a processor and a program storage device readable by the computer system, embodying a program of instructions executable by the processor to perform method steps for pre-rendering medical images for display on a viewing workstation. The method includes receiving three-dimensional medical image data, automatically identifying a region of suspicion within the three-dimensional medical image data, pre-rendering the three-dimensional medical image data into a sequence of two-dimensional images in which the identified region of suspicion is featured from a vantage point that is determined based on the location of the region of suspicion, and exporting the sequence of pre-rendered two-dimensional images for subsequent viewing.

The sequence of pre-rendered two-dimensional images may include two-dimensional images centered on the region of suspicion and taken from different vantage points, each vantage point determined differently based on the location of the region of suspicion.

The sequence of pre-rendered two-dimensional images may be exported into a PACS in format viewable from a PACS viewing workstation.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating a method for displaying pre-rendered medical images on a workstation according to an exemplary embodiment of the present invention;

FIG. 2 is a block diagram illustrating a system for performing the method shown in FIG. 1 according to an exemplary embodiment of the present invention;

FIG. 3 is a block diagram illustrating a partially interactive panel view according to an exemplary embodiment of the present invention;

FIG. 4A is a block diagram illustrating a vantage point for a pre-rendered two-dimensional image frame according to an exemplary embodiment of the present invention;

FIG. 4B is a block diagram illustrating a progression of vantage points representing a fly-thorough sequence of pre-rendered two-dimensional image frames according to an exemplary embodiment of the present invention; and

FIG. 5 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention may provide a novel approach for performing computer aided detection (CAD) on acquired medical image data to find one or more regions of interest and then pre-rendering the medical image data for subsequent display on a viewing terminal such that the location of the automatically detected regions of interest are used to determine a proper pre-rendering. In the proper pre-rendering, the pre-rendered image data, when displayed on a viewing station, provides suitable views with which a radiologist or other trained medical professional may use to render a diagnosis.

Additionally, the proper pre-rendering may include selecting a suitable gray level window based on a portion of the medical image data in the vicinity of the detected region of suspicion. According to one exemplary embodiment of the present invention, the suitable window level may be selected based on a determination as to the pathology of the region of suspicion, wherein there may be one or more predetermined suitable window levels to select from for a particular pathology. The pathology may be established, for example, as a part of the CAD procedure.

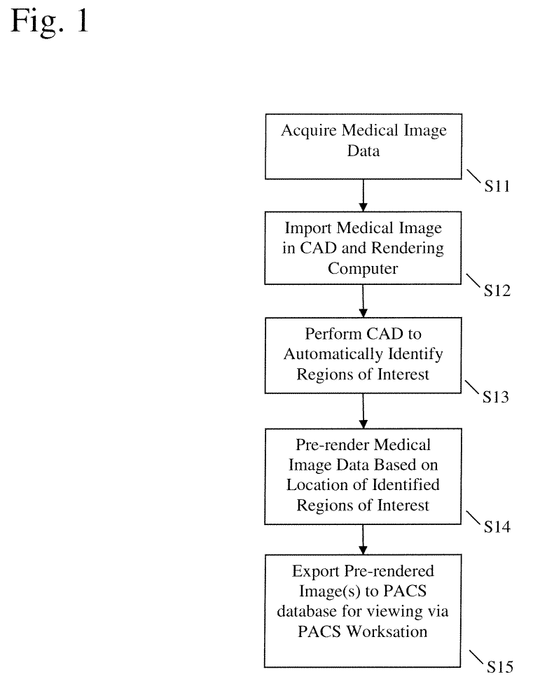

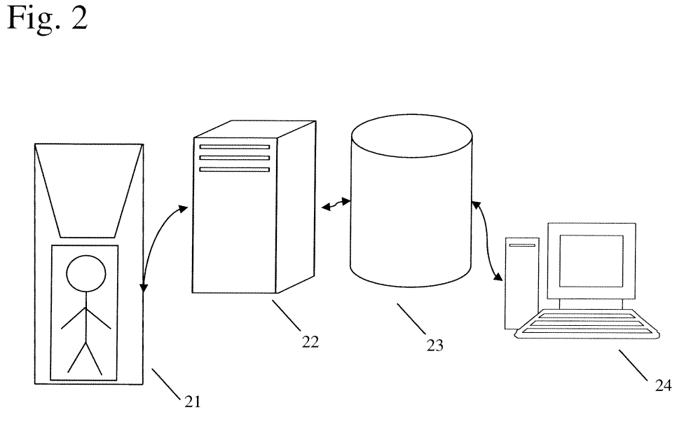

FIG. 1 is a flow chart illustrating a method for displaying pre-rendered medical images on a workstation according to an exemplary embodiment of the present invention. FIG. 2 is a block diagram illustrating a system for performing the method shown in FIG. 1. With respect to FIGS. 1 and 2, first medical image data may be acquired (Step S11). The medical image data may be magnetic resonance (MR) image data, computed tomography (CT) image data, positron emission tomography (PET) scanning, ultrasound image data or medical image data from some other modality. The medical image data may be acquired using a medical image device 21 such as an MR, CT and/or ultrasound scanner.

The acquired medical image data may then be imported into a three-dimensional image processing (CAD) and rendering computer 22 (Step S12). The image processing and rendering station 22 may be used to perform CAD to automatically identify one or more regions of interest (Step S13). Alternatively, CAD may be performed at a separate workstation and/or server.

According to some exemplary embodiments of the present invention, CAD may be performed fully automatically, without any user input. Alternatively, CAD may be performed semi-automatically, with the assistance of user input. In either event, CAD may be performed by analyzing the three-dimensional medical image data for evidence of elevated likelihood of disease, injury or other abnormality using one or more approaches known in the art. Examples of abnormalities include tumors, lesions, and nodules. When evidence of an abnormality is found, the location of the potential abnormality is marked as a region of suspicion.

After the location of one or more potential regions of interest have been automatically identified (Step S13), the medical image data may then be pre-rendered based on the locations of the automatically identified regions of interest (Step S14). Pre-rendering may include the generation of one or more two-dimensional image views. The two-dimensional image views may include frames of a motion picture sequence that may be subsequently displayed forward in sequence, backward in sequence, or stepped through frame-by-frame, and/or may include rendered single views.

Unlike conventional approaches for rendering medical image data, exemplary embodiments of the present invention may pre-render the medical image data to achieve a set of two-dimensional image views that clearly illustrate the region(s) of interest from one or more optimal vantage points. Thus rather than simply generating generic two-dimensional renderings in which the region of suspicion may or may not be clearly displayed, exemplary embodiments of the present invention take the location of the regions of interest into account when performing pre-rendering.

The optimal vantage points may include, for example, a vantage point showing each region of suspicion straight ahead and/or one or more vantage points showing the region of suspicion from various unobstructed angles. Optimized unobstructed view may be automatically created based on existing algorithms for three-dimensional view selection to minimize occlusion between the target structure and occluding structures. In each image frame, the region of suspicion may be substantially centered. The image frames may be subsequently displayed as a motion picture sequence, for example, where the region of suspicion is features as if from a moving camera that works its way around the region of suspicion, in a so-called “fly-around” view. In this way, the set of pre-rendered images may be interactively animated after-the-fact by the radiologist.

Exemplary embodiments of the present invention may also select, for each sequence of pre-rendered images, an appropriate gray level window based on each region of suspicion. Accordingly, the pre-rendered images may include a gray level window that is particularly suited for displaying the region of suspicion with a high degree of contrast and color-level detail that is typically selected for the diagnosis.

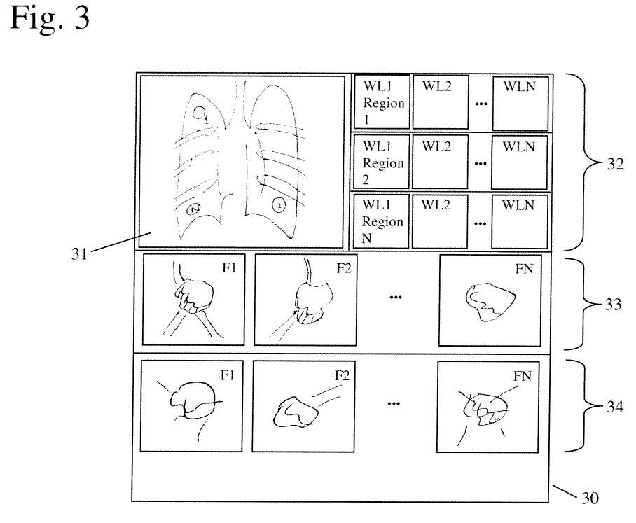

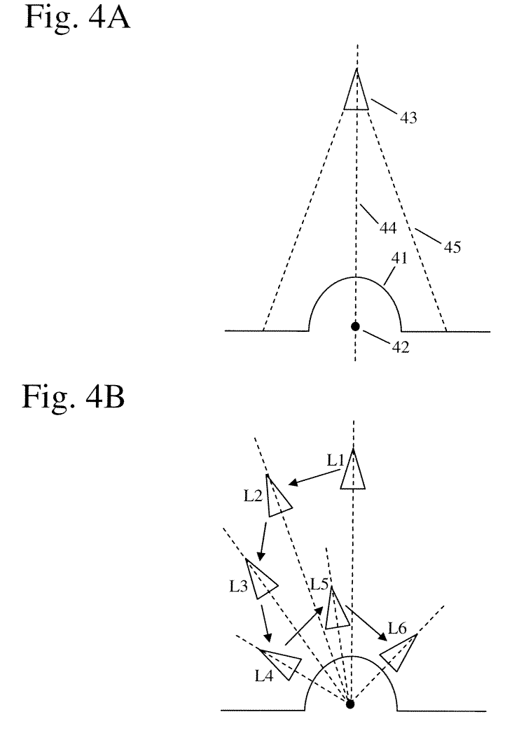

Additional details concerning the composition of the pre-rendered images are described below, for example, with reference to FIGS. 3, 4A, and 4B.

After the medical image data has been pre-rendered based on the location of the identified regions of interest (Step S14), the pre-rendered images may be exported (Step S15). The pre-rendered medical images may be exported either directly to a viewing workstation 24 or more likely, to a picture archiving systems (PACS) database 23. The pre-rendered medical images may subsequently be called up and displayed from the PACS database 23 on a simple display workstation 24.

Once called up, the radiologist may view the pre-rendered medical images, for example, from a partially interactive panel view. FIG. 3 is a block diagram illustrating a partially interactive panel view according to an exemplary embodiment of the present invention.

For a particular imaging study, exemplary embodiments of the present invention may generate one or more panel views. FIG. 3 illustrates an exemplary panel view 30 that may be called up and displayed from a PACS database on a display workstation. The panel view may include a scout image 31. The scout image may be an overview image illustrating one or more marked regions of interest. In the exemplary panel view 30, the scout image 31 illustrates a planar view of the lungs with three circular markings labeled “1,” “2,” and “N” representing a set of automatically identified regions of interest 1 through N.

Section 32 of the exemplary panel view 30 includes a series of close-up images in which each automatically identified region of suspicion is presented from an appropriate vantage point. The top row of section 32 illustrates close-up images for a first region of suspicion (region 1) at a plurality of preselected window gray levels (WL1, WL2, . . . , WLN).

Section 33 of the exemplary panel view 30 includes a series of pre-computed volume renderings (VRT), one for each region of suspicion (F1, F2, . . . FN corresponding to regions 1, 2, . . . , N). Each volume rendering may represent a fly-around view comprising a sequence of frames that may be watched as a moving picture or may be stepped through one-by-one, it may be a single representative 3-D view, or set of key views

Section 44 of the exemplary panel view 30 includes a series of pre-computed shaded surface display (SSD), one for each region of suspicion (F1, F2, . . . FN corresponding to regions 1, 2, . . . , N). Unlike the VRT discussed above, the SSD provides a detailed surface view without rendering the volume data. Each shaded surface display rendering may represent a fly-around view comprising a sequence of frames that may be watched as a moving picture or may be stepped through one-by-one, or it may be a single representative three-dimensional view, or set of key views.

FIG. 4A is a block diagram illustrating a vantage point for a pre-rendered two-dimensional image frame according to an exemplary embodiment of the present invention and FIG. 4B is a block diagram illustrating a progression of vantage points representing a fly-thorough sequence of pre-rendered two-dimensional image frames according to an exemplary embodiment of the present invention.

Referring to FIG. 4A, the region of suspicion 41 which may be, for example, a lesion candidate, may have a center 42. A vantage point of high diagnostic value may be automatically selected based on the position of the region of suspicion 41 by pre-rendering the three-dimensional image data from the point of view of a virtual camera 43. Here, the virtual camera 43 may be positioned at a vantage point that illustrates the region of suspicion 41 in high detail, for example, a head-on view that is perpendicular to the surface from which the region of suspicion protrudes. From this vantage point, the virtual camera 43 is aligned along a centerline 44 that passes though the center 42 of the region of suspicion 41. The virtual camera in this orientation may be used to generate a vantage point that illustrates a region of the medical image data within a field of view 45 of the virtual camera 43.

The two-dimensional pre-rendered image frames may be generated, for example, by selecting a position of the virtual camera angle and casing rays therefrom onto the vicinity of the region of suspicion. The point(s) at which the rays intercept the region of suspicion and the surrounding vicinity may then be rendered onto a two-dimensional image frame. The virtual camera may thereafter be relocated and another two-dimensional image frame may be calculated, for example, using ray casting techniques. The virtual camera may be repositioned a number of times along a path that may be predetermined or may be selected based on the nature of the region of suspicion and/or the surrounding area. In this way, a sequence of two-dimensional image frames may be calculated to represent a virtual fly-by.

FIG. 4B illustrates a progression of virtual camera angles defining a fly-by according to an exemplary embodiment of the present invention. The virtual camera may begin, for example, at a forward-facing location L1. A two-dimensional image frame may then be generated from that vantage point. The virtual camera may then be relocated to a second location L2 where a second image frame may be generated. From there, the virtual camera may be moved in sequence to positions L3, L4, L5, and L6, with a two-dimensional image frame being generated at each vantage point. Although FIG. 4B is illustrated in two-dimensions, the actual position of the virtual camera may be adjusted in three dimensions and may move along a path that images the region of suspicion from a wide range of angles and radii with respect to an x-axis, a y-axis and a z-axis.

According to exemplary embodiments of the present invention, the radiologist or other medical practitioner may have an ability to interact with the data display in some limited form which may include, for example, the ability to step through image frames that illustrate each region of suspicion from various different angles. Thus, the displayed data may comprise constrained pre-computed interactive views where the user may play the sequence of images as a moving picture or manually step through the images frame-by-frame. The user may also be provided with the ability to pause, rewind, fast forward and/or zoom. The moving picture may also be set to display in a continuous loop.

The image frames may, for example, be a sequence of DICOM derived images, with individual pixel levels calculated using any one of a number of three-dimensional computer graphics rendering algorithms such as z-buffering, shaded surface algorithms, etc. Alternatively, a separate DICOM image series may be derived which can be loaded and cinema scrolled or looped in the PACS workstation viewer.

The scout view 31 of FIG. 3 may be formed using any one of a number of well known simulated projection techniques used to form synthetic scout images in CT/MRI/PET etc. One exemplary approach for generating the symmetric scout view is to take the reconstructed attenuation volume from the CT and create a synthetic projection X-ray image by integrating the total attenuation in the perpendicular to the coronal plane along each column of the volume. Superimposed in the scout images are CAD markers that indicate the global automatic location and context for the CAD findings within the patient, the location of which may be determined by drawing the marker within the gray values of the derived synthetic projection (such as using a DICOM derived image and overriding the image gray values with a fixed text intensity gray value for the bitmap of the marker) taking only the coordinates of the CAD finding within the coronal plane, and ignoring the coordinate index perpendicular to the plane.

The window level slice images in FIG. 3, segment 32 may be formed by extracting the two-dimensional neighborhood around each respective CAD indentified region of suspicion in each corresponding axial CT slice and inserted to the appropriate sub-window location in the segment, applying the window level LUT and setting the resulting display value to that pixel in the segment sub-window. For example, all regions of interest centered ±10 slices of each respective finding may be inserted. This can be repeated for each respective finding at various preset window levels (WL1 . . . WLN) with corresponding LUTs.

The boundaries of the region of suspicion within the axial slices may be computed automatically from the automatically segmented extents of the candidate structure using automatic nodule segmentation algorithms known in the art for anatomical structures, and may optionally use the detected CAD region of suspicion as the seed point.

For the VRT segment 33 in FIG. 3, “fly arounds” for each finding can be automatically computed using automatically determined viewing pyramids parameters and viewpoint trajectories around the region of suspicion based on automatically detected surrounding structures and the lesion dimensions that permit unobstructed viewing of the region of suspicioned in cluttered environments. A segmentation of the region of suspicion may be used to determine the virtual camera parameters and to hide the other structures, for example, by suppressing rendering of regions around the segmentation that might come in between the virtual camera and the object. FIG. 4A demonstrates one scenario where the lesion is visible from the illustrated location of the virtual camera angle. For a complete view of the lesion, the camera may be moved along the path illustrated in FIG. 4B and snapshots may be taken at regular intervals. This path may be pre-computed based on the lesion location or learned from camera navigation patterns of the users when reviewing a lesion in a system that allows for interactive camera motion. Additionally, transparency and opacity maps may be automatically determined using existing algorithms. A similar approach may be applied for the SSD segment 34 in FIG. 3.

Each of the pre-rendered two-dimensional image sequences may be calculated using three-dimensional data and rendering algorithms and them may be parameterized by the respective parameters and N versions of the total image created each with sub images having the appropriate viewing parameters. For example, each window slice segment may have a varying Z slice value, each VRT or SSD subimage in the set may have a different spherical coordinate relative to the center of the region of suspicion and viewing pyramid parameters and lighting.

The ordered set of images may then be scrolled bi-directionally, by a user, through interactive scrolling in the two-dimensional PACS workstation or cycled automatically or intermittently viewed looping. Then, the user may experience the images as moving in a continuous interactive movie of the three-dimensional rendered views may then be archived and used to generate parallax in the viewer, as well as a shading and other cues normally available through static 3-D rendering on advanced workstations.

While exemplary embodiments of the present invention may not provide fully interactive arbitrary viewing, a diagnostically useful optimal or near-optimal pre-computed view sequence through automated selection of good viewing trajectories and parameters may be obtained. These images may allow sufficient three-dimensional information to be available to the viewer and thus the user may achieve many of the benefits of a full three-dimensional interactive rendering environment in interpretation of CAD findings.

According to an exemplary embodiment of the present invention, a standards based approach such as a DICOM derived series may be used to maintain ordering of the order set and allow for viewing on a variety of different vendor PACS workstation that implement the DICOM standard.

CAD may be performed on a medical image processing server that may receive the acquired reconstructed three-dimensional volumes, perform CAD processing, pre-render the order set of images and then transmit the resulting images to the PACS for storage and subsequent retrieval on a PACS workstation for interactive viewing of the order set of images. Alternatively many other implementation architectures may be possible.

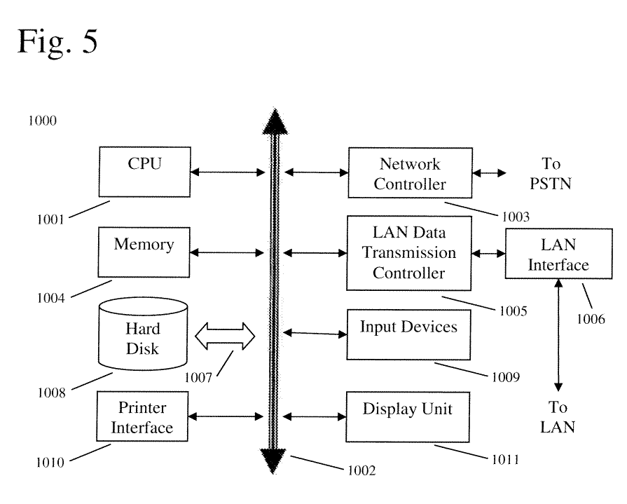

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

While exemplary embodiments provided herein may refer to three-dimensional image data, these examples are offered to provide for a simplified disclosure and it is to be understood that to higher dimensioned image data may also be used in a manner consistent with the exemplary embodiments described herein.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for displaying pre-rendered medical images on a workstation, comprising:
receiving three-dimensional medical image data;
automatically identifying a region of suspicion within the three-dimensional medical image data;
pre-rendering, using a rendering computer, the three-dimensional medical image data into a sequence of two-dimensional images in which the identified region of suspicion is depicted in a manner that is dependent upon the location of the identified region of suspicion;
storing of the sequence of pre-rendered two-dimensional images into a storage archive or medium; and
displaying the sequence of pre-rendered two-dimensional images stored in the storage archive or medium on a display device.

2. The method of claim 1, wherein the three-dimensional medical image data is a CT scan, an MRI, PET or an ultrasound image.

3. The method of claim 1, wherein the storage archive or medium is a PACS database.

4. The method of claim 1 wherein the display device is distinct from the rendering computer.

5. The method of claim 1, wherein the sequence of two-dimensional images includes a series of image frames that can be replayed as a cine moving image.

6. The method of claim 5, wherein when displayed on the display device, the cine moving image can be shown to move forward and backwards through the series of image frames according to user input.

7. The method of claim 5, wherein the cine moving image includes a virtual fly-by animation from the point of view of a virtual camera, wherein the position of the virtual camera changes as the animation progresses with the virtual camera pointed at the region of suspicion throughout the entire animation.

8. The method of claim 7, wherein the flight path of the virtual camera is determined based on the location of the region of suspicion relative to the surrounding image data.

9. The method of claim 1, wherein the region of suspicion is a lesion candidate.

10. The method of claim 1, wherein pre-rendering the three-dimensional medical image data into a sequence of two-dimensional images includes rendering the three-dimensional image data from a vantage point that is automatically selected to maximize diagnostic value of the two-dimensional images for determining whether the region of suspicion is an actual abnormality.

11. The method of claim 1, wherein depicting the region of suspicion in a manner that is dependent upon the location of the identified region of suspicion includes depicting the region of suspicion substantially in the center of each of the sequence of two-dimensional images.

12. The method of claim 1, wherein depicting the region of suspicion in a manner that is dependent upon the location of the identified region of suspicion includes depicting the region of suspicion with a window level that is selected based on the region of suspicion.

13. The method of claim 12, wherein selecting the window level based on the region of suspicion includes:
identifying a pathology for the region of suspicion; and
selecting a window level based on the identified pathology.

14. The method of claim 1, wherein the sequence of two-dimensional images includes multiple views of the region of suspicion from various angles.

15. A method for pre-rendering medical images in a computer, comprising:
receiving three-dimensional medical image data;
automatically identifying a region of suspicion within the three-dimensional medical image data;
pre-rendering the three-dimensional medical image data into a sequence of two-dimensional images in which the identified region of suspicion is depicted in a manner that is dependent upon the location of the identified region of suspicion; and
exporting the sequence of pre-rendered two-dimensional images to a storage archive or medium for subsequent viewing.

16. The method of claim 15, wherein the three-dimensional medical image data is a CT scan, an MRI, PET or an ultrasound image.

17. The method of claim 15, wherein sequence of two-dimensional images includes a series of image frames that can be replayed as a cine moving image.

18. The method of claim 17, wherein the cine moving image includes a virtual fly-by animation from the point of view of a virtual camera, wherein the position of the virtual camera changes as the animation progresses with the virtual camera pointed at the region of suspicion throughout the entire animation.

19. The method of claim 18, wherein the flight path of the virtual camera is determined based on the location of the region of suspicion relative to the surrounding image data.

20. The method of claim 15, wherein the region of suspicion is a lesion candidate.

21. The method of claim 15, wherein pre-rendering the three-dimensional medical image data into a sequence of two-dimensional images includes rendering the three-dimensional image data from a vantage point that is automatically selected to maximize diagnostic value of the two-dimensional image for determining whether the region of suspicion is an actual abnormality.

22. The method of claim 15, wherein the sequence of two-dimensional images includes multiple views of the region of suspicion from various angles.

23. A computer system comprising:
a processor; and
a program storage device readable by the computer system, embodying a program of instructions executable by the processor to perform method steps for pre-rendering medical images for storage, the method comprising:
receiving three-dimensional medical image data;
automatically identifying a region of suspicion within the three-dimensional medical image data;
pre-rendering the three-dimensional medical image data into a sequence of two-dimensional images in which the identified region of suspicion is depicted in a manner that is dependent upon the location of the identified region of suspicion; and
exporting the sequence of pre-rendered two-dimensional images to a storage archive or medium for subsequent viewing.

24. The computer system of claim 23, wherein the sequence of pre-rendered two-dimensional images includes two-dimensional images centered on the region of suspicion and taken from different vantage points, each vantage point determined differently based on the location of the region of suspicion.

25. The computer system of claim 23, wherein the sequence of pre-rendered two-dimensional images is exported into a format viewable from a PACS workstation.
